(19) United States
(12) Patent Application Publication
(10) Pub. No.: US 2006/0155610 A1
(43) Pub. Date: Jul. 13, 2006

(54) Transaction portal system

(76) Inventors: Russell S. Neville, Tualatin, OR (US); Richard D. Sauter, Tualatin, OR (US)

Correspondence Address: IPSOLON LLP, 111 SW COLUMBIA, SUITE 710, PORTLAND, OR, 97201, US

(21) Appl. No.: 11/036,504

(22) Filed: Jan. 13, 2005

(51) Int. Cl. G06Q 30/00

(52) U.S. Cl. 705/26

(57) ABSTRACT

A transaction portal system includes a transaction processing portal that is in network communication with and serves separate and distinct vendors that each have multiple corresponding customers. A transaction client system is associated with each of the multiple customers of each vendor. The transaction client system of each customer is in networked communication with one or more devices of the customer (e.g., computer printers) that are serviced by the vendor. The devices provide to the transaction client system via network communication a supply or service notification of a supply or service requirement of the device. The supply or service notification may include a device identifier and a device type identifier. The transaction client system sends the supply or service notification to the transaction processing portal over an external public network, such as the Internet, and the transaction processing portal forwards the supply or service notification to the vendor.

### FIELD OF THE INVENTION

The present invention relates to a transaction portal system and, in particular, to a transaction portal system that obtains information directly from devices for which transactions are conducted through the transaction portal system.

### BACKGROUND AND SUMMARY OF THE INVENTION

A wide variety of electronic business portals are available through which vendors of all sizes can offer and sell goods and services. For example, well-known electronic business sites such as Amazon.com and ebay.com offer different types of portal services through which others can conduct commerce. These well-known electronic business portals operate in the conventional manner of electronic commerce.

A user searches for and identifies a desired item on the electronic business site and purchases it, whether from the site host (e.g., amazon.com) or from any of the vendors hosted on the site. These conventional electronic commerce purchases can reduce some of the effort required of a customer, because the customer may conduct the transaction from the comfort of wherever his or her computer is located.

However, some aspects of these conventional electronic commerce purchases remain as inconvenient as they have ever been for the customer, particularly for purchases relating to goods or services for commercial or industrial devices used in business. As one example, many computer networks have at least multiple computer printers, and sometimes a large number of computer printers. In the case of making purchases for this type of equipment, a worker must typically monitor the status of each individual device and then manually identify and order services or replacement goods as needed. As the numbers of devices increase, the manual effort required can be time-consuming and burdensome.

Accordingly, the present invention provides a transaction portal system that includes a transaction processing portal that is in network communication with and serves separate and distinct vendors that each have multiple corresponding customers. A transaction client system is associated with each of the multiple customers of each vendor. The transaction client system of each customer is in networked communication with one or more devices of the customer (e.g., computer printers) that are serviced by the vendor.

The devices provide to the transaction client system via network communication a supply or service notification of a supply or service requirement of the device. The supply or service notification typically includes a device identifier and a device type identifier. The transaction client system sends the supply or service notification to the transaction processing portal over an external public network, such as the Internet, and the transaction processing portal forwards the supply or service notification to the vendor.

The network communication between the devices for which goods or services are purchased and the transaction client system can provide automatic polling of supply and service needs for the devices. In addition, the transaction client system can use the device identifier and device type identifier to provide automatic suggestions of goods or services in view of the supply or service notification. As a result, a worker can monitor and order supplies and services for a great many more devices than if the monitoring and ordering were done manually. In addition, for a vendor who supplies or services a customer's device on a regular basis, transaction portal system allows the vendor to serve the customer more efficiently while also providing a valuable additional service to the customer.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a simplified block diagram of a transaction portal system according to the present invention.

FIG. 2 is a block diagram illustrating an exemplary customer as having a customer network with an arbitrary number of one or more network-connected devices.

FIG. 3 is a flow diagram of a transaction portal vendor method by which a vendor interacts with a transaction processor.

FIG. 4 is an illustration of a customer request data structure received at a transaction processor when a customer accesses it.

FIG. 5 is a flow diagram illustrating a transaction portal client method.

FIG. 6 is an illustration of a graphical user interface of a customer transaction portal client in a “manage devices” mode for active devices.

FIG. 7 is an illustration of a graphical user interface of a customer transaction portal client in the “manage devices” mode for other devices.

FIG. 8 is an illustration of a graphical user interface of customer a transaction portal client displaying exemplary details about a selected device.

FIG. 9 is an illustration of a graphical user interface of a customer transaction portal client in a message center mode.

FIG. 10 is a simplified block diagram of an alternative transaction portal system according to the present invention.

### DETAILED DESCRIPTION OF PREFERRED EMBODIMENTS

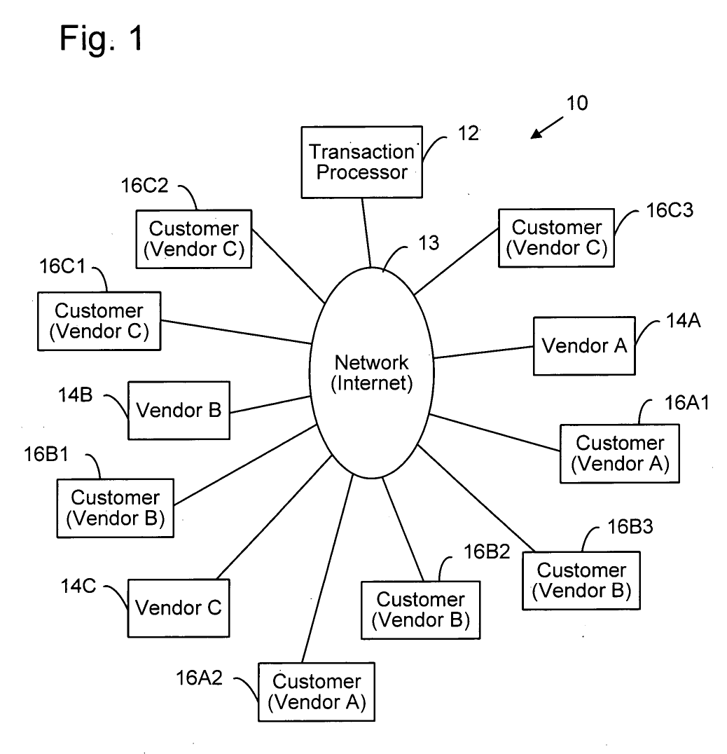

FIG. 1 is a simplified block diagram of a transaction portal system 10 according to the present invention. Transaction portal system 10 functions as an electronic broker through which separate and distinct vendors (e.g., resellers, dealers, OEMs, etc.) can provide and sell goods and services to their respective customers. In one preferred implementation, transaction portal system 10 receives information, including requests for supplies and services, automatically from networked devices of vendor customers and forwards the requests to the respective vendor to be fulfilled.

Transaction portal system 10 includes a transaction processor or portal 12 that is in networked communication over a network 13 (e.g., the Internet) with multiple distinct vendors 14A-14C (referred to generally or collectively as vendor 14 or vendors 14). Three vendors 14 are shown for purposes of illustration, but it will be appreciated that an arbitrary number of vendors 14 could be in networked communication with transaction processor 12. Likewise, transaction processor 12 may be implemented as any number of computers in communication with each other.

For each of vendors 14, multiple distinct customers (referred to generally or collectively as customer 16 or customers 16) are also in networked communication with transaction processor 12. Two customers 16A1 and 16A2 are illustrated as corresponding to vendor 14A, three customers 16B1, 16B2, and 16B3 are illustrated as corresponding to vendor 14B, and three customers 16C1, 16C2, and 16C3 are illustrated as corresponding to vendor 14C. As with the number of vendors 14, the numbers of customers 16 is simplified for purposes of illustration. In operation, the numbers of customers 16 for each vendor 14 can be arbitrary.

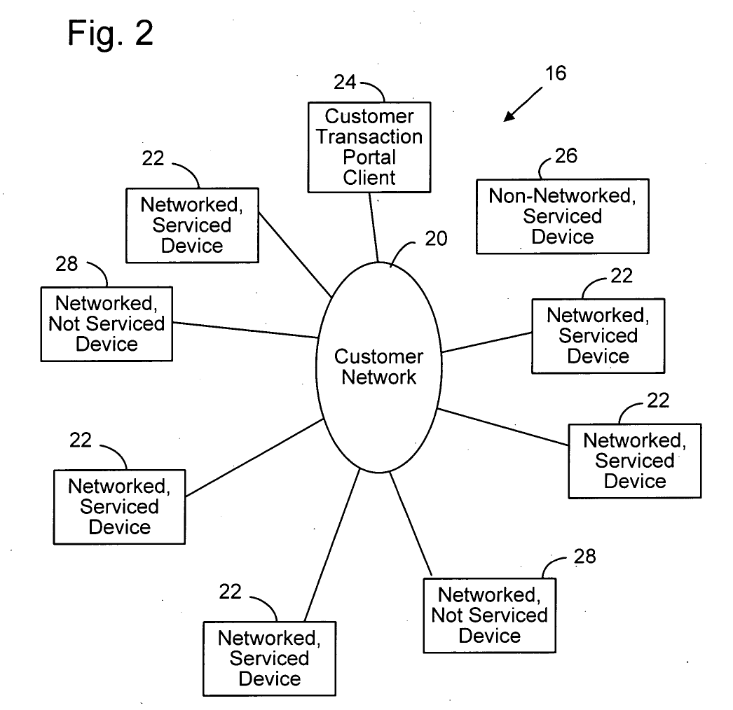

FIG. 2 is a block diagram illustrating an exemplary customer 16 as having a customer network 20 with an arbitrary number of one or more network-connected devices 22 that are serviced by a selected one of vendors 14. Customer network 20 may be implemented as a local area network (LAN), or a wide area network, over which devices 22 communicate with at least a customer transaction portal client 24.

Devices 22 may be connected directly to customer network 20 or may be connected to it through other network devices (not shown). For example, devices 22 may include computer printers that are connected directly to network 20 or are connected thereto through an associated computer (e.g., a workstation computer) or a print server. Customer network 20 may also include any number of network-connected devices 24 that are not serviced by the selected vendor. In addition, customer 16 may also have one or more non-networked devices 26 that are not connected to network 20, but are serviced by the selected vendor 14. Networked devices 22 and non-networked devices 26 may be referred to as the serviced devices 22, 26 that are serviced by the selected vendor 14.

The arrangement between the selected vendor 14 and the exemplary customer 16 for the servicing of devices 22, 26 may be formed in any conventional manner. For example, the arrangement may be part of a purchase, maintenance, and supply contract under which the devices 22, 26 are purchased from and serviced by selected vendor 14. Alternatively, the arrangement may be only a maintenance and supply contract that provides for periodic services, on-call services, or both. The maintenance may include repair, cleaning, adjusting or tuning of devices 22, 26, either on-call or periodically, according to the terms of the arrangement, and the supplying may include replacement of any or all of the consumable supplies used by devices 22, 26. Alternately, there may be no contractual relationship between the vendor 14 and exemplary customer 16. In such a situation, any service requests originated by the end-customer would be handled by the vendor on a time-and-materials (T&M) basis.

As an example of one implementation of the present invention, the following description will be directed to serviced devices 22, 26 that provide printed output for a computer network, such as computer printers (laser, ink jet, or other), facsimile machines, multi-purpose machines, copiers, plotters, etc. It will be appreciated, however, that the present invention is similarly applicable to other types of network devices, such as computers, factory machines, sensors, etc.

Networked devices 22 communicate over customer network 20 with customer transaction portal client 24, which may be implemented as software running on a computer 28 connected to network 20. Typically, the computer 28 would be a workstation used by a customer worker who oversees the servicing of devices 22, 26, such as an office manager or a network technician. Customer transaction portal client 24 would typically be one of multiple applications running on computer 28 and generally could operate in the background behind other applications being used by the customer worker.

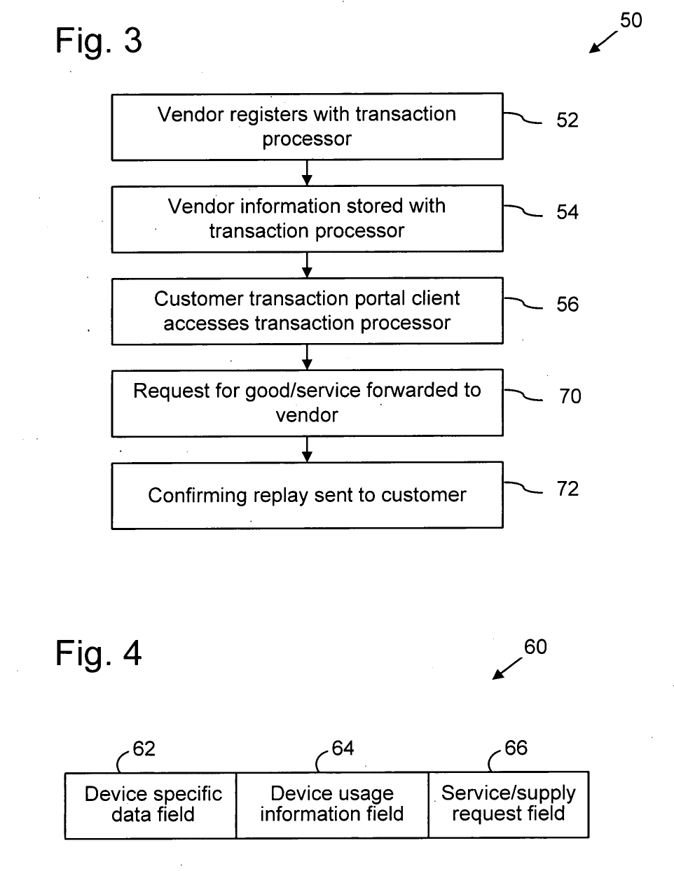

FIG. 3 is a flow diagram of a transaction portal vendor method 50 by which a vendor interacts with transaction processor 12. Vendor transaction portal method 50 may be implemented as software running on a vendor computer (not shown) in network communication with transaction processor 12. Typically, the vendor computer would be a workstation used by a vendor worker who oversees or schedules at least the servicing of customer devices, and possibly also the supplying of them. The software implementing vendor transaction portal method 50 may be run within a browser on the vendor computer 28 or may alternatively be a separate application.

In step 52 a vendor registers as a vendor with transaction processor 12. Registration may include providing any or all of the following vendor information, including a registration name and password, a logo or other indicia to be reproduced at customer transaction portal clients 24, pricing for supplies or services to be available to customers of the vendor, and a banner advertisement or notice to be displayed at customer transaction portal clients 24.

Typically, transaction portal system 10 and transaction processor 12 would be operated by an entity other than any of vendors 14. The entity operating transaction portal system 10 would provide the transaction portal services in consideration of fees charged to or paid by the vendors 14. For example, the fees could be paid as a flat fee for each vendor 14 or could be based upon the number of customer devices 22, 26 served by each vendor 14. Other fee arrangements could alternatively be used.

In step 54 the vendor information is stored by the transaction processor 12, at least some of the vendor information being available to the customer transaction portal clients 24 of the vendor customers.

In step 56 the customer transaction portal client 24 of a customer of the vendor accesses transaction processor 12 to request a good or service from the vendor.

FIG. 4 is an illustration of a customer request data structure 60 received at transaction processor 12 when a customer accesses it. Customer request data structure 60 may include any or all of a device-specific data field 62, a device usage information field 64, and a service/supply request field 66. Device-specific data field 62 may include any or all of a device serial number, a device model number, a current device state indicator (e.g., idle, active, error, warning, etc.), and a consumable level indicator.

The device usage information field 64 may include, for example, a meter reading (e.g., time of operation reading, usage count, etc.), indicating usage and maintenance characteristics of the device. The service/supply request field 66, which may optionally be split into separate service and supply request fields, indicates a specific service or supply request for the device. With respect to computer printers, for example, a service request may indicate any printer error code conventionally provided by a printer, such as a paper feed error, an optical system error, a motor error, a heater error, a communication error, etc.

In step 70 the request for the good or service is forwarded to the vendor with the information included in the customer request data structure 60. Requests may be forwarded to vendors by various mechanisms including email, phone (digital), fax, direct database insertion using mechanisms such as XML/SOAP, etc.

In step 72 a confirming reply is sent to the customer transaction portal client 24 via the transaction processor 12. With regard to a service request, the reply may be originated automatically from the transaction processor 12 as having been received, or may include a specific response from the vendor, either alone or with an automatic component. With regard to a good or supply request, the reply may typically be originated automatically from the transaction processor 12 and may include pricing or availability information retrieved from the vendor information stored at the transaction processor 12.

Upon receiving the request for a good or service from a customer, the vendor may ship or arrange delivery of the requested good and may schedule a technician to service the device. Alternatively, goods requests may be directed to a drop-ship supplier (e.g., wholesaler) that ships the requested good directly to the customer on behalf of the vendor.

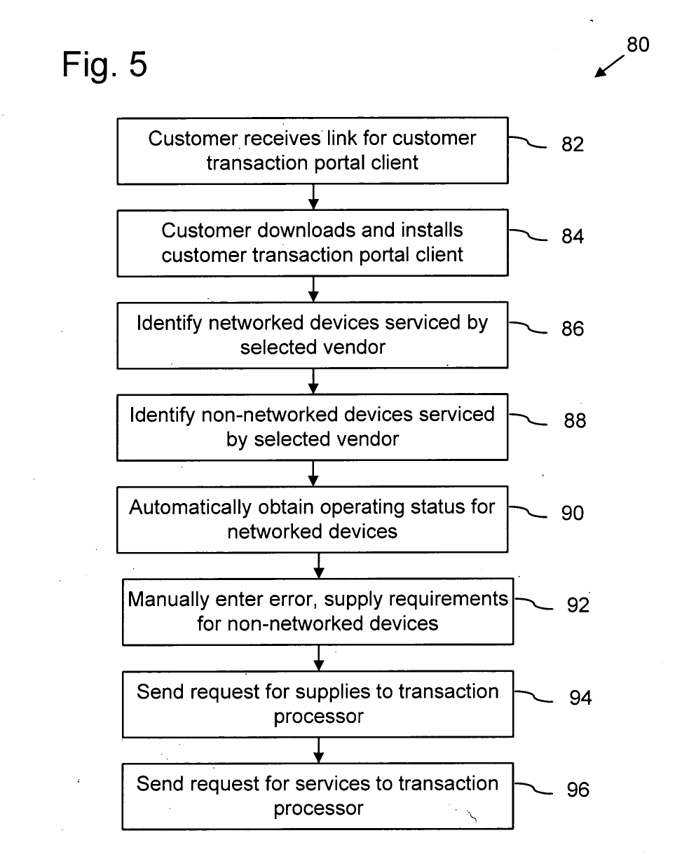

FIG. 5 is a flow diagram illustrating a transaction portal client method 80, which includes customer transaction portal client 24 receiving information from networked devices 22 and about non-networked devices 26 and sending the information to transaction processor 12. Various steps of transaction portal client method 80 are implemented in computer software that operates on computer 28 or at transaction processor 12.

In step 82 a vendor customer receives from or on behalf of a vendor a computer network link to access and download software for the customer transaction portal client. For example, the link may point to transaction processor 12, or may point to another network location.

In the step 84, the customer downloads and installs the software for the customer transaction portal client.

In step 86 the networked devices that are on a customer network and serviced by a selected vendor are identified in the customer transaction portal client. For example, each networked device 22 may be identified with respect to any or all of its network address (e.g., internet protocol (IP) address), its model name or number (e.g., including manufacturer), and its serial number.

The identification of networked devices 22 may be performed partly or completely automatically by customer transaction portal client 24. If customer transaction portal client 24 cannot obtain desired identifying information automatically from the device 22 over customer network 20, such as a fax machine or telephone unit, a customer worker or a vendor worker may manually enter the information into customer transaction portal client 24.

In step 88 the non-networked devices of the customer serviced by a selected vendor are identified in a customer transaction portal client. For example, each non-networked device 26 may be identified with respect to any or all of its model name or number (e.g., including manufacturer) and its serial number. Customer transaction portal client 24 cannot obtain desired identifying information automatically from the device 26 because it is not connected to customer network 20. Accordingly, a customer worker or a vendor worker manually enters the information into customer transaction portal client 24.

In step 90 the customer transaction portal client automatically obtains operating status information from each of the networked devices 22. The operating status information may indicate normal operation, or a supply indication, or an error indication, or some other status indication. For example, a warning or supply indication could indicate that a consumable supply is low or depleted. With regard to printers, for example, an error indication could be any error code conventionally provided by a printer, such as an optical system error, a motor error, a heater error, a communication error, etc.

In step 92 a customer worker manually enters into customer transaction portal client any service, error or supply requirement for any of non-networked devices 26.

In step 94 a supply request is sent over network 13 to transaction processor 12 for supplies or goods required for any of devices 22, 26. The supplies or goods may be specified automatically by communication directly between a networked device 22 and customer transaction portal client 24, or may be entered manually by a customer worker with regard to a networked device 22 or a non-networked device 26.

In step 96 a service request is sent over network 13 to transaction processor 12 requesting a service for any of devices 22, 26. The service request may be specified automatically by communication directly between a networked device 22 and customer transaction portal client 24, or may be entered manually by a customer worker with regard to a networked device 22 or a non-networked device 26.

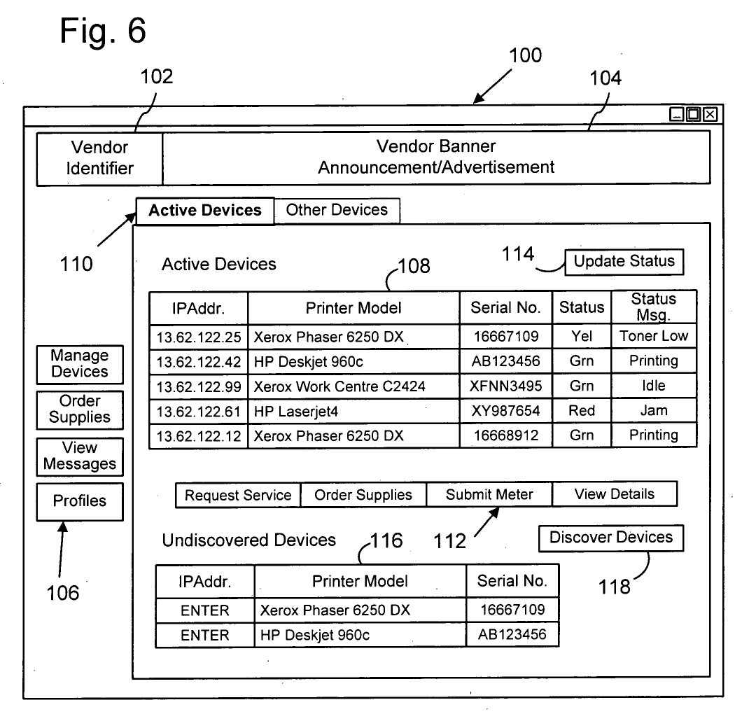

FIG. 6 is an illustration of a graphical user interface 100 of customer transaction portal client 24 in a “manage devices” mode in which a customer worker can manage the serviced devices 22, 26. Interface 100 includes a vendor identifier 102 (e.g., name, logo, etc.) and an announcement/advertising banner 104 that are part of the vendor information that the vendor provides to transaction processor 12. Identifier 102 and announcement/advertising banner 104 give interface 100 an appearance that is specific to the vendor 14 to illustrate that customer transaction portal client 24 is a service provided by the vendor.

Graphical user interface 100 can be customized by or for vendor 14 at multiple levels, including announcement/advertising banner 104, vendor identifier 102, and even an overall look and feel of the display. On a periodic basis, changes to announcement/advertising banner 104, vendor identifier 102, or other information from the vendor such as catalogs, messages, etc. are pulled or pushed from portal 12 to the portal client 24, which is updated to reflect the changes automatically.

Graphical mode controls 106 allow the customer worker to select the manage devices mode from among an order supplies mode, a view messages mode, and a profiles mode. In the illustrated manage devices mode, a block 108 lists networked devices 22 that customer transaction portal client 24 has identified on the customer network 20.

Graphical tabs 110 allow the customer worker to select between the “active devices” (e.g., networked devices 22) and “other devices” (e.g., devices 26 without network control). For each of devices 22, interface 100 may list in networked device block 108 device identifying information, such as the device type (e.g., printer model) and serial number, and a network address (e.g., IP address). In addition, one or more status indicators may be listed such as a colored status indicator (e.g., designated in FIG. 6 by the words red, yellow, and green to indicate overall critical, warning or no-error states, respectively) and a status message that provides a more specific indication of status.

Graphical device controls 112 allow the customer worker to select for one or more specified devices a request service control, an order supplies control a submit meter control, or a view details control. In addition, a manual update status control 114 allows the worker to activate customer transaction portal client 24 to poll the status of networked (active) devices 22. Such manual activation of the status polling may be in addition to automatic status polling that occurs on a scheduled basis.

Interface 100 also includes an undiscovered devices block 116. A manual discover device control 118 allows the worker to activate customer transaction portal client 24 to poll the network to discover networked (active) devices 22 that client 24 had not previously identified. Such manual activation of the device discovery polling may be in addition to automatic device discovery polling that occurs on a scheduled basis.

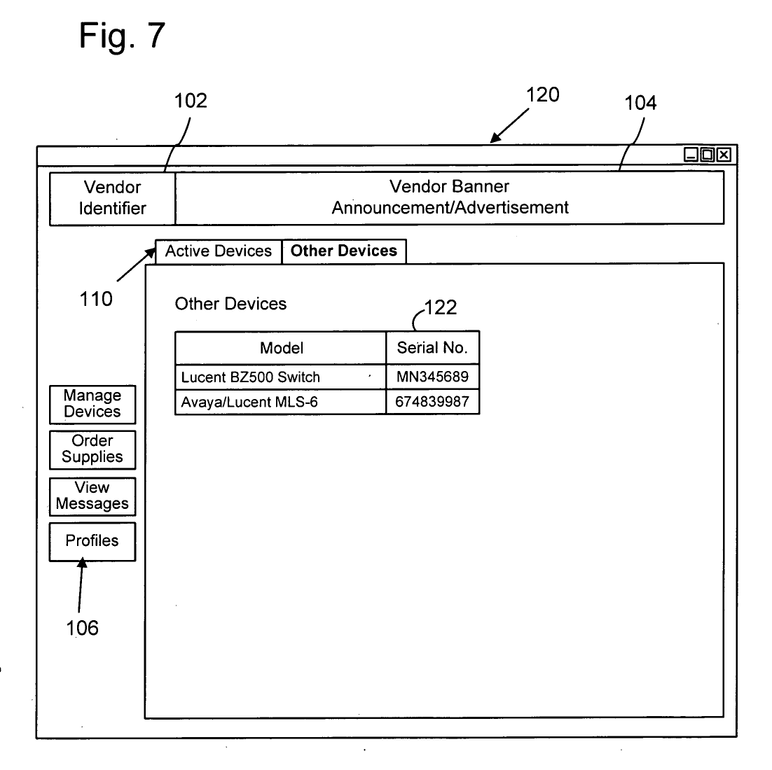

FIG. 7 is an illustration of a graphical user interface 120 of customer transaction portal client 24 in the “manage devices” mode for the “other devices” tab 110. Interface 120 in this illustration continues to display vendor identifier 102 and banner 104, as will each of the interface displays. Interface 120 also includes an “other devices” block 122 that lists available identifying information for devices 26. Interface 120 does not include controls for activating access to the devices 26 because those devices are not controllable by customer transaction portal client 24 over customer network 20.

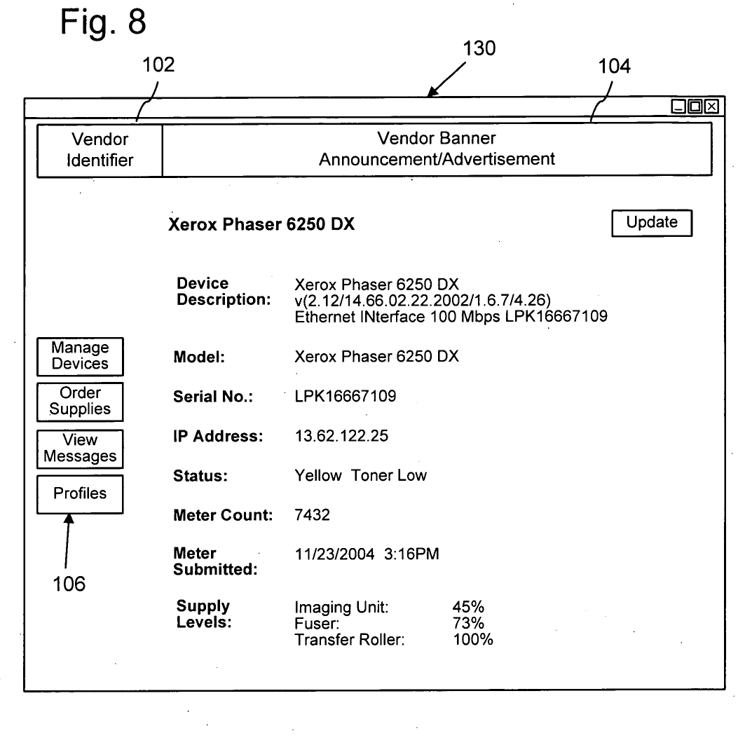

FIG. 8 is an illustration of a graphical user interface 130 of customer transaction portal client 24 displaying exemplary details about a selected device upon activation of the “view details” control 112. Interface 130 in this illustration continues to display vendor identifier 102 and banner 104, as will each of the interface displays. Interface 130 also includes various identifying and informational details about the selected device and its status.

In addition to information provided in networked device block 108 (FIG. 6), interface 130 may further include a device description, a more detailed explanation of status, a meter count and a date when it was last submitted to the vendor for tracking, and any available supply status information.

Remaining interfaces provided by customer transaction portal client 24 may be of a generally conventional format within the unique context of the transaction portal system 10 (e.g., continuing to display vendor identifier 102 and banner 104). For example, the overall order supplies mode provided in response to the order supplies graphical mode control 106, and the device-specific order supplies mode provided in response to the order supplies device control 112, provides an order template from with the worker can order supplies.

For a device with a warning supply status or a critical supply status, customer transaction portal client 24 can automatically populate the required supplies in the order template, together the pricing for the supplies. The supplies and their prices may have been delivered to customer transaction portal client 24 for the known devices 22, 26 during a previous communication with transaction processor 12. The supplies and their prices may have been included in vendor information delivered to transaction processor 12. In addition, the customer worker may manually enter any supplies to be ordered. An order activation control sends the supplies order over network 13 to transaction processor 12.

Similarly, the view messages mode and the profiles mode provided by the eponymous mode controls 106 provide, respectively, messages and orders transmitted to and from transaction processor 12 relating to requests or system operation, and fields to manage the names of the customer workers who handle interactions with system 10. Updates to profiles information is provided to the vendor 14 via transaction processor 12. Likewise, device controls 112 (request service and submit meter) display and transmit information to and from transaction processor 12.

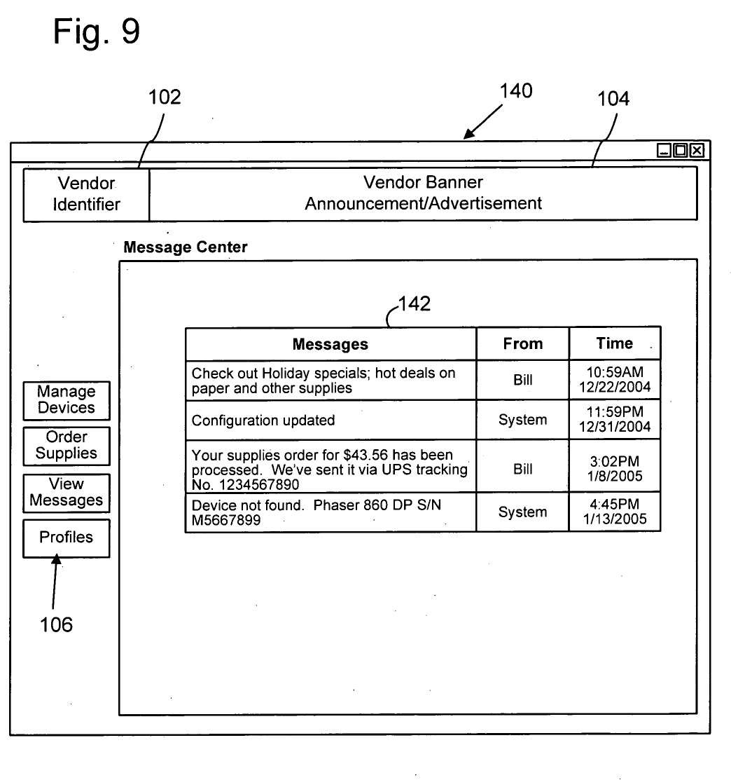

FIG. 9 is an illustration of a graphical user interface 140 of customer transaction portal client 24 in a message center mode. Interface 140 displays messages 142 sent from vendor 14 to one or more targeted customers 16 or to all the customers 16 of the vendor 14. Interface 140 continues to display vendor identifier 102 and banner 104, and the look and feel of the vendor 14. The messages 142 are sent by vendor 14 through customer transaction portal client 24 and may include any or all of messages containing directed marketing messages, service notification, status updates, etc.

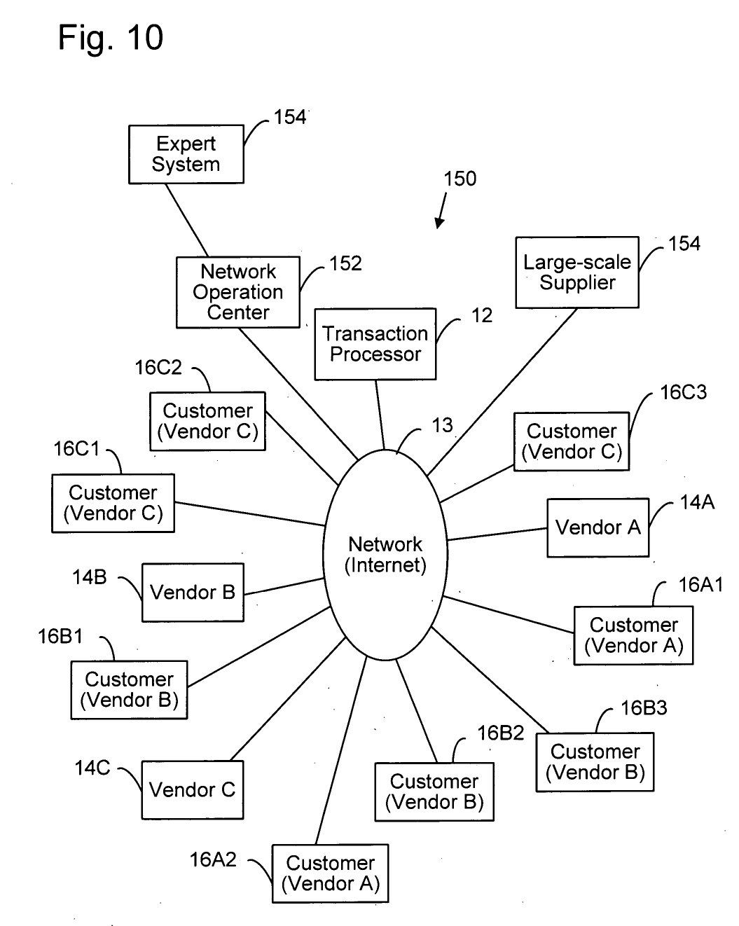

FIG. 10 is a simplified block diagram of an alternative transaction portal system 150 according to the present invention. Transaction portal system 150 is substantially the same as transaction portal system 10 and so includes the same reference numerals for analogous elements. Transaction portal systems 10 and 150 differ in that the latter further includes a network operation center 152 (sometimes NOC 152) through which communication between transaction processor 12 and vendors 14 pass. NOC 152 can be co-located with transaction processor 12 or can be at a different location.

Network operation center 152 monitors service and supply requests sent to vendors 14. In one implementation, NOC 152 accommodates multiple makes or brands of device, such as multiple makes of computer printer (e.g., HP, Xerox, Lexmark, Canon, etc.). In another implementation, each of plural NOCs 152 accommodates one or more different makes or brands of device. In the implementation with multiple NOCs 152, transaction processor 12 sends service or supply requests via the network operation centers 152 corresponding to the makes or brands in the request.

According to prearranged terms with the vendor 14, the network operation center 152 may transmit a copy of a supply request to a wholesale supplier or other large-scale supplier 154 to have the requested supplies drop-shipped directly to the requesting customer. The NOC 152 then forwards the supply request to the vendor, which processes the billing for the supply order. Such a drop-shipping arrangement for supplies allows the servicing vendors, which are typically relatively small entities, to avoid relatively expensive stocks of supplies.

Likewise, according to prearranged terms with the vendor 14, the network operation center 152 may transmit a copy of a service request to an expert system or knowledgebase 156, such as one maintained by a device manufacturer, to have any readily available service solutions transmitted directly to the vendor with the service request, including suggested replacement parts. Such accessing of an expert system or knowledgebase 156 before beginning the requested service can better prepare the vendor worker to resolve the service request by having needed parts, test protocols, etc.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A transaction portal system, comprising:
a transaction processing portal in network communication with and serving plural separate and distinct vendors that each have plural corresponding customers, and
a transaction client system associated with each of the plural customers of each of the plural vendors, the transaction client system of each customer being in networked communication with one or more devices of the customer that are served by the vendor to which the customer corresponds, the devices providing to the transaction client system via network communication a supply or service notification of a supply or service requirement of the device, the supply or service notification including a device identifier and a device type identifier;
wherein the transaction client system sends the supply or service notification to the transaction processing portal and the transaction processing portal forwards the supply or service notification to the vendor to which the customer corresponds.

2. The system of claim 1 in which the transaction client system automatically obtains from a device a supply or service notification of a supply or service requirement of the device without interaction of a transaction client system operator.

3. The system of claim 1 in which the transaction client system includes a transaction client user interface that lists the one or more devices of the customer that are served by the vendor to which the customer corresponds together with identifying information for each device and status information for each device, the status information for each device being provided from each device via the network communication to the transaction client system.

4. The system of claim 3 in which the transaction client user interface includes an update status control by which a transaction client system operator can commence a poll of the status of the devices.

5. The system of claim 1 in which the transaction client system includes a transaction client user interface that lists the one or more devices of the customer that are served by the vendor to which the customer corresponds together with identifying information for each device, the transaction client user interface including a request control by which a transaction client system operator sends the supply or service notification to the transaction processing portal.

6. The system of claim 1 in which the supply or service notification includes a request for a service, the system further comprising a network operation center to which the transaction processing portal also sends the supply or service notification, the network operation center automatically requesting from an expert system a proposed response to the supply or service notification and sending the proposed response to the vendor in association with the supply or service notification.

7. The system of claim 1 in which the supply or service notification includes a supply request, the system further comprising a network operation center to which the transaction processing portal also sends the supply or service notification, the network operation center automatically forwarding the supply or service notification to a supplier associated with the vendor for fulfillment.

8. The system of claim 1 in which the transaction processing portal periodically sends vendor information updates to the transaction client system.

9. The system of claim 1 in which the one or more devices include one or more computer output devices.

10. A transaction portal method, comprising:
obtaining at a transaction client system a supply or service notification of a supply or service requirement of each of plural customer devices via network communication over a customer network between the devices and the transaction client system, the customer devices, the transaction client system, and the customer network being associated with a customer of a selected vendor;
sending the supply or service notification from the transaction client system to a transaction processing portal over an external public network; and
forwarding the supply or service notification via the external public network to the selected vendor from the transaction processing portal.

11. The method of claim 10 in which the supply or service notification includes a device identifier and a device type identifier.

12. The method of claim 10 further comprising automatically obtaining at the transaction client system a supply or service notification of a supply or service requirement of the device without interaction of a transaction client system operator.

13. The method of claim 10 in which the transaction client system includes a transaction client user interface, the method further comprising:
listing the plural customer devices in the transaction client user interface together with identifying information for each device and status information for each device; and
obtaining the status information for each device via network communication over the customer network from between device and the transaction client system.

14. The method of claim 10 in which the supply or service notification includes a request for a service, the method further comprising
sending the supply or service notification from the transaction client system to a network operation center;
automatically sending from the network operation center to an expert system a request for a proposed response to the supply or service notification; and
sending a proposed response from the expert system to the vendor in association with the supply or service notification.

15. The method of claim 10 in which the supply or service notification includes a supply request, the method further comprising:
sending the supply or service notification from the transaction client system to a network operation center; and
automatically forwarding the supply or service notification to a supplier associated with the vendor for fulfillment.

16. A computer readable medium having stored therein transaction portal client software, comprising:
software for obtaining a supply or service notification of a supply or service requirement of each of plural customer devices via network communication from the devices, the supply or service notification including for each customer device a device identifier and a device type identifier; and
software for sending the supply or service notification from to a transaction processing portal over an external public network.

17. The medium of claim 16 further comprising software for automatically obtaining a supply or service notification of a supply or service requirement of the device without interaction of a transaction client system operator.

18. The medium of claim 16 further comprising software for a transaction client user interface, comprising:
software for listing the plural customer devices in the transaction client user interface together with identifying information for each device and status information for each device; and
obtaining the status information for each device via network communication from each device.
